(19) United States
(12) Patent Application Publication
(10) Pub. No.: US 2016/0079850 A1
(43) Pub. Date: Mar. 17, 2016

(54) Boost Converter Apparatus And Method

(71) Applicant: Continental Automotive Systems, Inc., Auburn Hills, MI (US)

(72) Inventors: Justin Edward Cresswell, Ferndale, MI (US); Dean Edward Condron, Grand Blanc, MI (US); Deepak Gulur Ananda Murthy, Rochester Hills, MI (US)

(21) Appl. No.: 14/485,954

(22) Filed: Sep. 15, 2014

(51) Int. Cl. H02M 3/156; B60L 11/02

(52) U.S. Cl. CPC H02M 3/156; B60L 11/02

(57) ABSTRACT

A boost circuit includes a transistor that switches on and off a boost converter. A temperature from a sensor is received and the temperature is the temperature of the boost circuit. The transistor is selectively switched on and off to cut the current to a boost supply based upon temperature.

### TECHNICAL FIELD

This application relates to boost converters and, more specifically, the operation of the control circuit for the boost converters.

### BACKGROUND OF THE INVENTION

Vehicles use various types of components that are powered by power supplies. In one example, a boost converter is a DC-to-DC power converter with an output voltage greater than its input voltage. A boost converter may be used with a fuel injector to boost the amount of voltage available to this component. For example, a boost power supply for diesel fuel injectors may be required to produce a voltage of 50 volts+/−5%.

When a boost converter is used with fuel injectors, a voltage pulse is first applied and then typically a minimum recovery time occurs before voltage for the next injector is applied. This voltage applied to the injector will cause a dip in the boost voltage supply. The dip in the voltage becomes worse at cold temperatures because of the loss of large aluminum capacitors that are often used. This in turn requires the power supply is capable of supplying larger amounts of current because the capacitors are unable to provide the energy. All of this is normally not a problem at cold temperatures because the components are cool and will be able to handle the extra power. However, over the rest of the temperature range these currents settings (which are used for the regulation being set to meet the extreme cold) result in an over capacity of the power supply which normally results in an inefficient (high power loss) and high radiated/conducted emission problems.

These limitations have not been addressed by previous approaches. As a result, some user dissatisfaction with previous approaches exists.

### BRIEF DESCRIPTION OF THE DRAWINGS

For a more complete understanding of the disclosure, reference should be made to the following detailed description and accompanying drawings wherein:

FIG. 1 comprises a block diagram of system utilizing a boost converter various embodiments of the present invention;

FIG. 2 comprises a circuit diagram of a boost converter control circuit according to various embodiments of the present invention;

FIG. 3 comprises a drawing of some waveforms present in the circuits described herein according to various embodiments of the present invention;

FIG. 4 comprises a block diagram showing inputs into a controller according to various embodiments of the present invention;

FIG. 5 comprises a flowchart showing the operation of a boost converter control circuit according to various embodiments of the present invention;

FIG. 6 comprises a table showing various control actions based upon circuitry temperature according to various embodiments of the present invention; and

FIG. 7 comprises a table showing various actions based upon temperature and gas pedal position according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described herein that switch a transistor (e.g., a MOSFET) on and off to cut the current to a boost supply based upon temperature other parameters. For example, during idle times, an engine may be hot and the current may be reduced. As the temperature becomes higher, the current to the boost supply is limited by switching it off sooner. Switching the transistor off sooner prevents too much current to flow from the battery into the load.

In many of these embodiments, a boost circuit includes a transistor that switches on and off a boost converter. A temperature from a sensor is received and the temperature is the temperature of the boost circuit. The transistor is selectively switched on and off to cut the current to a boost supply based upon temperature.

In some examples, the engine may be hot and the current may be reduced. In some aspects, as the temperature becomes higher, the current to the boost supply is limited by switching it off sooner. In some examples, switching the transistor off allows current to flow to the boost circuit.

In other aspects, other parameters besides temperature are used in the switching determination. Other parameters may include the amount of depression on the gas pedal. Other examples are possible. In some examples, the transistor comprises a MOSFET.

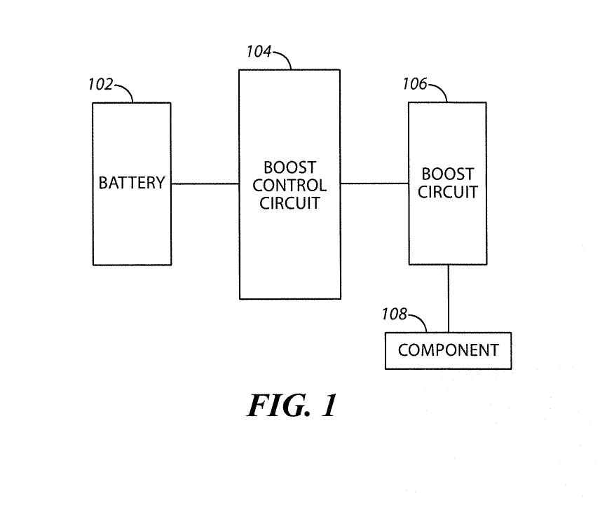

Referring now to FIG. 1, one example of a boost converter system is described. The system 100 includes a battery 102, a boost control circuit 104, and a boost circuit 106. The battery 102 may be any battery source that is used with vehicles.

The boost control circuit 104 as described elsewhere herein switches a transistor (e.g., a MOSFET) or other switching element (or elements) on and off to cut current to the voltage supplied to the boost circuit 106 based upon temperature other parameters. For example, during idle times, an engine may be hot and the current may be reduced. As the temperature gets higher, the current to the boost circuit 106 is limited by switching the transistor off sooner. Switching the transistor off allows current to flow to the boost supply. The boost circuit 106 is a circuit that supplies power to one or more vehicle components 108. The components 108 may, in one example, be fuel injectors, but other examples of components are possible.

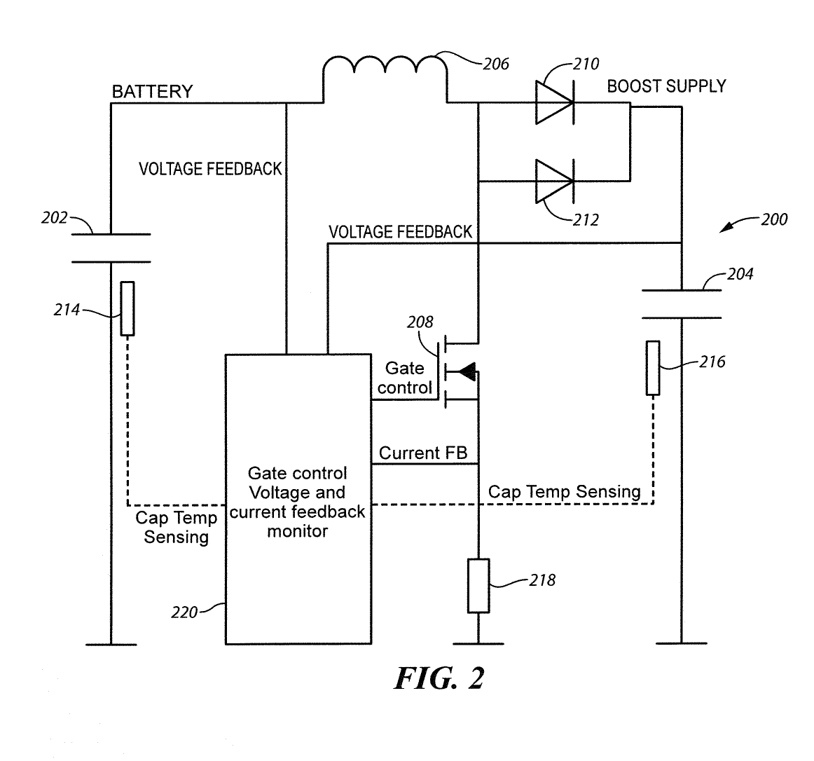

Referring now to FIG. 2, one example of a boost control circuit 200 is described. The boost control circuit 200 includes a first capacitor 202, a second capacitor 204, an inductor 206, a MOSFET 208, a first diode 210, a second diode 212, a first sensor 214, a second sensor 216, a resistor 218, and a controller 220.

The first capacitor 202 and the second capacitor 204 store energy for use in a boost circuit coupled to the output of the boost control circuit 200. The function of the inductor 206 is to transfer electrical energy from the lower potential battery to the higher potential VBOOST. The MOSFET 208 is a switching element controlled by the controller 220 that allows power and current to a boost circuit that is coupled to the output of the boost control circuit 200. The function of the first diode 210 and the second diode 212 is to prevent a back flow of current from the higher potential boosted voltage back into the battery. The first sensor 214 and second sensor 216 are any type of sensing device that sense temperature. The function of the resistor 218 is to sense the current flowing via the MOSFET 208 for detection of the peak current. This as well could be for example a current transformer or Hall Effect sensor.

As mentioned, the controller 220 switches the MOSFET 208 on and off to cut current to a boost supply based upon temperature other parameters. For example, during idle times, an engine may be hot and the current may be turned off. As the temperature gets higher, limit the current by switching it off sooner. Switching the transistor off allows current to flow.

For example, when the current is too high (above a predetermined threshold) the controller 220 switches the MOSFET 208 off. Thus, current flows through the diodes 210 and 212 into the boost circuit. It will be appreciated that various voltages can also be monitored by the controller. As various voltages go low (e.g., fall below a predetermined threshold), there may be a need to charge the inductor 206 more and get more current if needed. When the temperature increases, the current into the boost circuit is limited by not switching the MOSFET 208 back down (i.e., the MOSFET 208 is switched off sooner than it normally would be deactivated). In this way, power into the boost circuit is regulated based at least partially upon temperature. As explained elsewhere herein, other parameters can also be used to regulate the amount of energy and the timing of transferring this energy into the boost circuit.

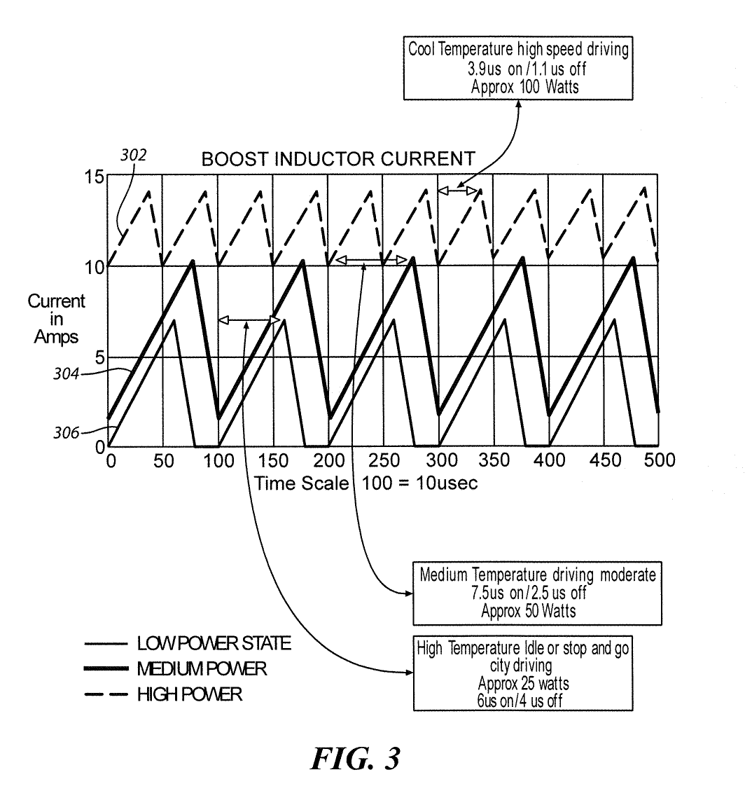

Referring now to FIG. 3, one example of a graph showing the booster inductor current as a function of time. As shown in FIG. 3, there are three waveforms. A first waveform 302 indicates operation during cool temperature high speed driving. In one example, the MOSFET is on 3.9 us and off 1.1 us off. Approximately 100 watts of power are available to be consumed by the injectors.

A second waveform 304 indicates operation during cool temperature high speed driving. In one example, the MOSFET is on 7.5 us on and off 2.5 us. Approximately 50 watts of power are available to be consumed by the injectors.

A third waveform 306 indicates operation during high temperature idle or stop and go city driving. In one example, the MOSFET is on 6 us and off 4 us but with a lower peak current shutdown than in the waveform 306. Approximately 25 watts of power are available to be consumed by the injectors.

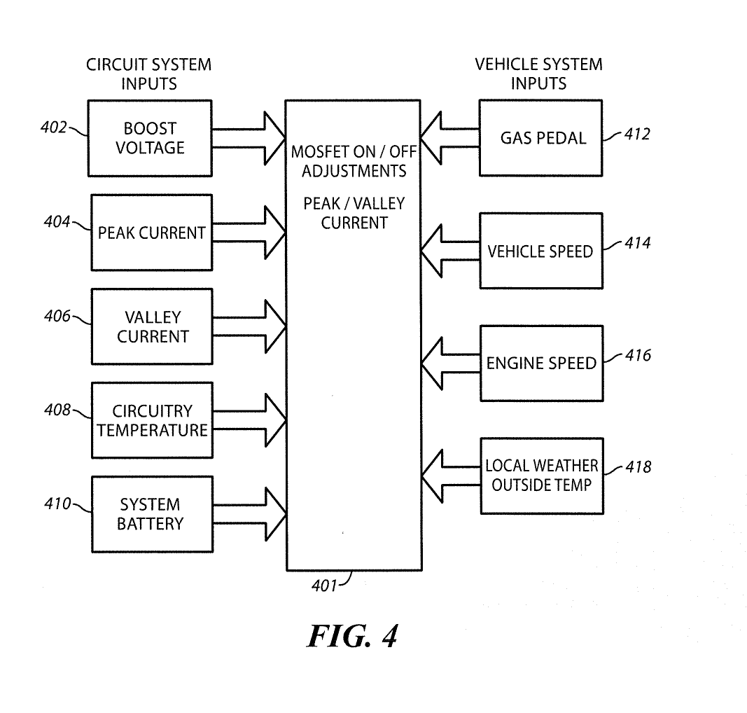

Referring now to FIG. 4, one example of an approach of making MOSFET on/off adjustments and regulating peak/valley current is described. Various circuit inputs are received by a controller 401. The controller 401 takes the input values and makes on and off adjustments to the MOSFET, for example, by adjusting peak and valley current values.

A boost voltage value 402 is received and represents a voltage value of the boost circuit and can be obtained from a voltage sensor. A peak current value 404 is received and represents the peak current value of the inductor. A valley current value 406 is received and represents the bottom (lowest) value of the current flowing through inductor. A circuitry temperature value 408 is received and represents the temperature of the circuitry. For example, a thermometer or other sensor may obtain this value. A system battery voltage value 410 is received and represents the voltage level of the battery.

Various vehicle system inputs are also received. More specifically, a gas pedal value 412 is received and represents an amount of push a driver exerts on the gas pedal of the vehicle. A vehicle speed value 414 is received and represents the speed at which the vehicle is traveling. An engine speed value 416 is received and represents the speed of the engine. A local weather outside temperature value 418 is received.

As discussed elsewhere herein, the received values are used to regulate the amount of current, voltage, and power allowed to flow into the boost control circuit. This regulation is accomplished by activating or deactivating a transistor at particular times.

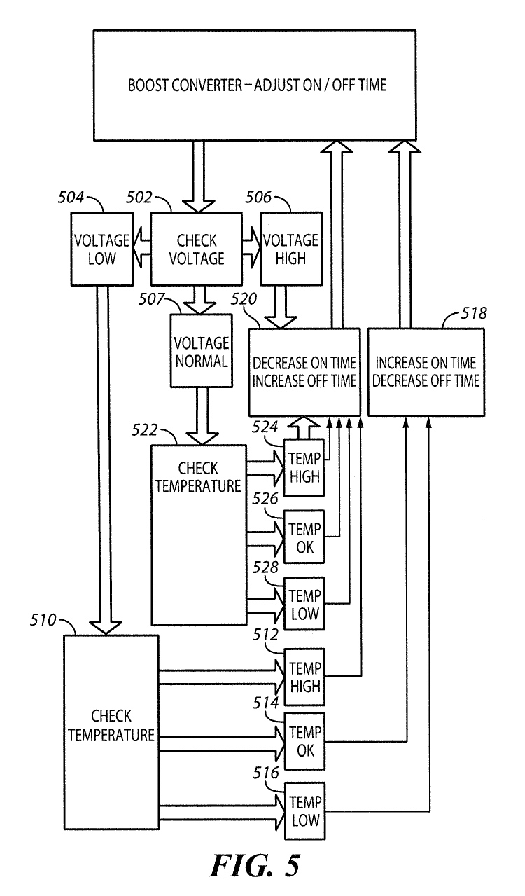

Referring now to FIG. 5, one example of an approach for adjusting the MOSFET operation is described. At step 502, boost converter adjust on/off time of the MOSFET is entered. The on/off time is entered because this will allow more or less energy to be transferred from the battery to the boost circuit based on inputs like temperature, pedal position, vehicle speed. A transfer of more energy from the battery is equivalent to a high power capacity at the boosted voltage output. At step 504, a check of the voltage of boosted voltage is made. A low voltage path 506, a normal voltage path 507, or a high voltage path 508 may be followed based upon the sensed voltage. If the low voltage path 506 is followed, at step 510, a check of the circuitry temperature is made.

Based upon the outcome of this step, three paths may be followed. More specifically, a temperature high path 512, a temperature acceptable path 514, or a temperature low path 516 may be followed.

If the temperature high path 512 is followed, at step 520 the on time of the MOSFET is decreased and the off time of the MOSFET is increased.

If the temperature acceptable path 514 or the temperature low path 516 are followed, at step 518 the system increases the on-time of the MOSFET and decreases the off time of the MOSFET.

If the voltage high path 506 is followed, at step 520 the on time of the MSOFET is decreased and the off time of the MOSFET is increased.

If the voltage normal path 507 is followed, a check of the temperature is made at step 522. The temperature can be sensed by appropriate sensors (e.g., sensors 214 and 216 shown in FIG. 1). Three paths can be followed based upon the temperature that is sensed: temperature high path 524, a temperature acceptable path 526, and a temperature low path 528. Any of these paths lead to step 520 where the on time of the MOSFET is increased and the off time is decreased.

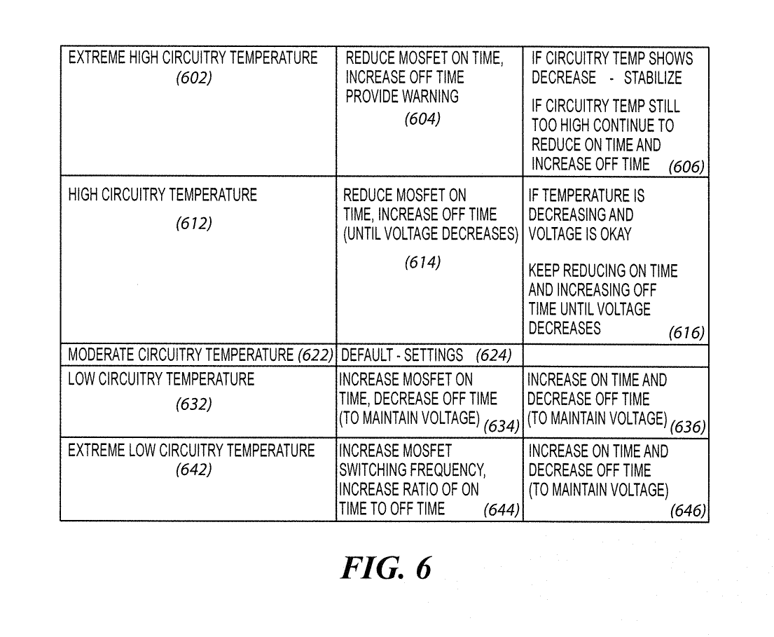

Referring now to FIG. 6, one example of the operation of a boost control circuit is described. At extremely high circuitry temperatures (602), at step 604 the MOSFET on-time is reduced. The off-time is increased and a warning is provided to the driver. At step 606 and if temperature of the circuitry shows a decrease, the on and off times are stabilized. If the temperature of the circuitry still continues to be too high (e.g., the temperature is above a predetermined value), then the system continues to reduce the on time of the MOSFET and increase the off time of the MOSFET.

At high circuitry temperatures (612), at step 614 the MOSFET on time is reduced and the off time is increased. This is performed until the voltage of boosted output decreases. At step 616 and if the temperature of the circuitry and the voltage are within acceptable values, the on-time is reduced and the off time is increased until the voltage decreases (e.g., to a desired level).

For moderate circuitry temperatures (622), at step 624 default settings for the on-time and off time of the MOSFET are used.

For low circuitry temperatures (632), at step 634 the on-time of the MOSFET is increased, and the off time is decreased to maintain the voltage of the boosted output. Next at step 636, the on-time of the MOSFET is increased, and the off time is decreased to maintain the voltage of the boosted output voltage.

For extremely low circuitry temperatures (642), at step 644 the switching frequency of the MOSEFT is increased and the on-time to OFF time is also increased. Next and at step 646, the on-time of the MOSFET is increased, and the off time is decreased to maintain the voltage of the boosted output voltage.

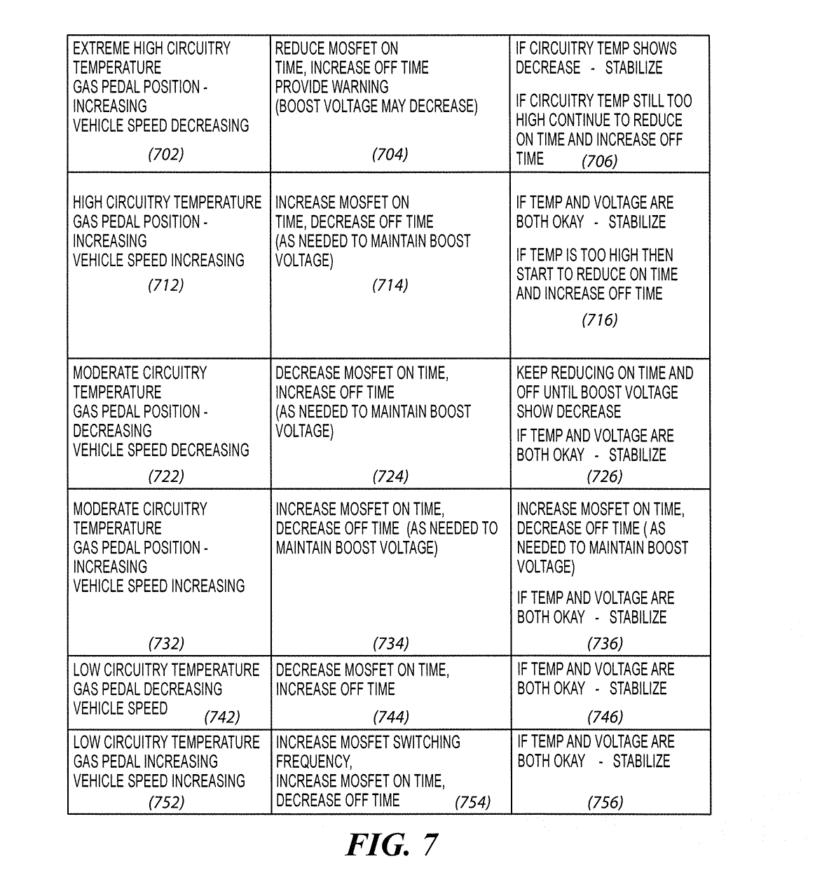

Referring now to FIG. 7, another example of an approach to control the operation of a boost control circuit is described. With high circuitry temperature and the gas pedal position increasing and the vehicle speed decreasing (702), at step 704 the MOSFET on time is decreased and the of time is increased. A warning to the driver is also provided. At step 706, if the temperature shows a decrease, the switch on and off times are stabilized. If the circuitry temperature is still too high continue to reduce the on time and increase the off time of the MOSFET.

With high circuitry temperature and gas pedal position increasing and vehicle speed increasing (712), at step 714 increase the MOSFET on-time, decrease the off time (as needed to maintain boost voltage). At step 716, if the temperature of the circuitry shows a decrease, the switch on and off times are stabilized. If the circuitry temperature is still too high start to reduce the on time and increase the off time of the MOSFET.

With moderate circuitry temperature and the gas pedal position decreasing and the vehicle speed decreasing (722), at step 724 decrease the MOSFET on-time, increase the off time (as needed to maintain boost voltage). At step 726, keep reducing on time until the voltage shows a decrease. If the temperature and the voltage are acceptable, the switch on and off times are stabilized.

With moderate circuitry temperature and the gas pedal position increasing and the vehicle speed increasing (732), at step 734 increase the MOSFET on-time, decrease the off time (as needed to maintain boost voltage). At step 736, increase the MOSFET on time and decrease the off time (as needed to maintain the boost voltage). If the temperature and the voltage are acceptable, the switch on and off times are stabilized.

With low circuitry temperature and the gas pedal decreasing and the vehicle speed (742), at step 744 decrease the MOSFET on-time, increase the off time. At step 746 if the temperature and the voltage are acceptable, the switch on and off times are stabilized.

With low circuitry temperature and the gas pedal increasing and the vehicle speed increasing (752), at step 754 increase the MOSFET switching frequency, increase the MOSFET on time, and decrease the MOSFET of time. At step 756 if the temperature and the voltage are acceptable, the switch on and off times are stabilized.

It should be understood that any of the devices described or mentioned herein (e.g., the controllers, the sensors, any presentation or display devices, or any external devices) may use a computing device to implement various functionality and operation of these devices. In terms of hardware architecture, such a computing device can include but is not limited to a processor, a memory, and one or more input and/or output (I/O) device interface(s) that are communicatively coupled via a local interface. The local interface can include, for example but not limited to, one or more buses and/or other wired or wireless connections. The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory devices described herein can include any one or combination of volatile memory elements (e.g., random access memory (RAM), such as dynamic RAM (DRAM), static RAM (SRAM), synchronous dynamic RAM (SDRAM), video RAM (VRAM), and so forth)) and/or nonvolatile memory elements (e.g., read only memory (ROM), hard drive, tape, CD-ROM, and so forth). Moreover, the memory may incorporate electronic, magnetic, optical, and/or other types of storage media. The memory can also have a distributed architecture, where various components are situated remotely from one another, but can be accessed by the processor.

The software in any of the memory devices described herein may include one or more separate programs, each of which includes an ordered listing of executable instructions for implementing the functions described herein. When constructed as a source program, the program is translated via a compiler, assembler, interpreter, or the like, which may or may not be included within the memory.

It will be appreciated that any of the approaches described herein can be implemented at least in part as computer instructions stored on a computer media (e.g., a computer memory as described above) and these instructions can be executed on a processing device such as a microprocessor. However, these approaches can be implemented as any combination of electronic hardware and/or software.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of operating a boost circuit, the boost circuit including a transistor that switches on and off a boost converter, the method comprising:
receiving a temperature from a sensor, the temperature being the temperature of the boost circuit;
selectively switching the transistor on and off to cut the current to a boost supply based upon temperature.

2. The method of claim 1 wherein the boost circuit is disposed in a vehicle with an engine, and the engine may be hot and the current is turned off.

3. The method of claim 2, wherein as the temperature becomes higher, the current to the boost supply is limited by switching the transistor off sooner.

4. The method of claim 3, wherein switching the transistor off allows current to flow to the boost circuit.

5. The method of claim 1, wherein other parameters besides temperature are used to determine the switching.

6. The method of claim 5, wherein the other parameters comprise the amount of depression on the gas pedal.

7. The method of claim 1, wherein the transistor comprises a MOSFET.

8. An apparatus for operating a boost circuit, the boost circuit including a transistor that switches on and off a boost converter, the method comprising:
an interface with an input and an output, the input configured to receive a temperature from a sensor, the temperature being the temperature of the boost circuit;
a controller coupled to the interface, the controller configured to selectively switch the transistor on and off to cut the current to a boost supply based upon the temperature.

9. The apparatus of claim 8 wherein the boost circuit is disposed in a vehicle with an engine, and the engine may be hot and the current is turned off.

10. The apparatus of claim 9, wherein as the temperature becomes higher, the current to the boost supply is limited by switching off the transistor sooner.

11. The apparatus of claim 10, wherein switching the transistor off allows the current to flow to the boost circuit.

12. The apparatus of claim 8, wherein the controller utilizes other parameters to determine the switching.

13. The apparatus of claim 12, wherein the other parameters comprise the amount of depression on the gas pedal.

14. The apparatus of claim 8, wherein the transistor comprises a MOSFET.
